(19) United States
(12) Patent Application Publication
(10) Pub. No.: US 2026/0352361 A1
(43) Pub. Date: Nov. 5, 2026

(54) A METHOD FOR DELAY MONITORING

(71) Applicant: Belden Solutions N.V., Olen (BE)

(72) Inventors: Marc VAN DESSEL, Heist-op-den-Berg (BE); Marc MOESKOPS, Hulshout (BE)

(73) Assignee: Belden Solutions N.V., Olen (BE)

(21) Appl. No.: 19/108,037

(22) PCT Filed: Aug. 31, 2023
(86) PCT No.: PCT/EP2023/073930

§ 371 Date: Feb. 28, 2025

(30) Foreign Application Priority Data
Sep. 1, 2022 (DE) 10 2022 122 190.3

(51) Int. Cl. H04J 3/06; H04W 24/08

(52) U.S. Cl. CPC H04J 3/0667; H04W 24/08

(57) ABSTRACT

A method for transmitting data between two end points A, B, which in particular requires a common TimeOfDay at both end points A, B in order to monitor the differential delay, sends and receives time stamps from both sides as both use the same time reference, characterized in that the differential delay measurement is performed by combining the results of two measurements into a single number indicating the change in differential delay compared to the differential delay at the beginning of the measurement.

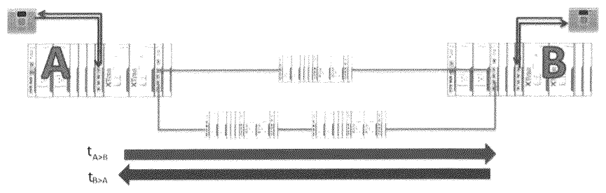

The invention relates to a method for transmitting data between two endpoints A, B, which in particular requires a common TimeOfDay at both endpoints A, B in order to monitor the differential delay, the method transmitting and receiving time stamps from both sides as both use the same time reference, according to the features of the generic term of claim 1.

Current differential delay protection applications rely on equal communication latency between the two endpoints of the application. In the figure, the time taken to transmit data from A to B should be the same (or have a minimal variation) as the time taken to transmit data from B to A. The difference between the two is called the differential delay of the service. The difference between the transmission time in both directions is called the differential delay of the service.

Current differential protection applications often use protocols such as IEEEC37.94, which typically rely on a TDM network between the two sides. When these applications are moved to an Ethernet-based communications infrastructure, they leverage the TDMoIP capabilities of the Ethernet network. These types of networks always have some jitter. In addition, the jitter of the TDMoIP service depends on several factors, such as the addition of additional services over the network and the type of data used by the other services.

When using current differential protection applications over an Ethernet-based network, the network must be able to control the differential protection. Typically, the maximum allowable differential delay is in the range of 50 microseconds to 400 microseconds. Preferably, the network has the capability to measure and/or monitor the differential delay and provide this information to the user of the network. This allows the user to detect any change in the differential delay.

### MEASUREMENT OF DIFFERENTIAL DELAY

To monitor differential delay without using external test equipment, the system typically requires a common TimeOfDay at both endpoints. Transmit and receive time stamps from both ends can be easily compared since both use the same time reference. However, the accuracy of the measurement (microsecond level) precludes a simple time synchronization technology for both nodes, such as the Network Time Protocol. More accurate mechanisms such as a GPS clock for each node or time distribution using IEEE1588 PTP are usually complex and expensive.

In the above and the following context, the terms “side A” and “end point A” are used equivalently. The same applies to “side B” and “end point B”.

Therefore, the invention is based on the problem to provide a simple time synchronization technology for both nodes (end points A, B) at least while maintaining the accuracy of the measurement (microsecond level).

This problem is solved by the features of patent claim 1.

According to the invention, the differential delay measurement is provided by combining the results of two measurements into a single number indicating the change in differential delay compared to the differential delay at the beginning of the measurement.

To eliminate the dependence on the IEEE 1588 PTP protocol, the solution according to the invention shows that only the change in differential delay over time needs to be measured without knowing the exact differential delay.

If the initial differential delay is too high, the current differential protection application simply does not work at startup. This typically does not result in a potential protection fault that could damage the power distribution. However, it is much more important to know the change in differential delay than to know the actual differential delay itself. The transition from a working situation (differential protection under control) to a non-working situation (differential protection out of range) has a much greater impact on the power distribution network, as the protection application may perform an unnecessary shutdown of certain sections.

The invention describes a solution (hence a method) for accurately measuring the change in differential delay without having a common time of day at both endpoints. This means that the solution can be used when synchronous Ethernet is used or even when adaptive and internal clocking are combined. The solution also works when synchronous Ethernet fails between the two sides and each side uses its own internal clock.

The differential delay measurement combines the results of the two measurements to provide a single number that indicates the change in differential delay compared to the differential delay at the beginning of the measurement.

Both measurements are required, otherwise not all application cases can be measured accurately.

### Measurement 1: Transmission Delay Change Between Side A and Side B.

The first measurement measures the change in transmission delay between the two directions, but relies on the fact that both sides are synchronized (e.g., using synchronous Ethernet).
Side A and B each have a counter that is incremented with each cycle of their own internal clock,
Side A sends a message to side B at local time tA1,
Side B receives the message at local time tB1 and acknowledges the message and includes the value of tB1 in the message,
Side A receives the acknowledgement at local time tA2,
Side A calculates (i) the round trip time rA1=tA2−tA1 and (ii) the initial offset offsetA1=tB1−tA1−rA1/2.

If the transit time changes in one of the two directions and the measurement is repeated, the calculated offset (OffsetA2) changes. This can be used to indicate a change in differential delay.

The absolute value of the change in differential delay can be calculated as follows:

ddA=2×(offsetA2−offsetA1)×internal clock period

### Measurement 2: Clock Difference Between Side A and Side B

The second measurement is used to correct the first measurement if both sides are no longer synchronized. In this case, the local times on both sides are no longer frequency synchronized, resulting in an unreliable measurement of the transmission delay with measurement 1.

To correct the result, measurement 2 compares the clock frequencies of both sides by looking at the internal transmission rate and the rate of incoming packets. The difference in the transmit and receive rates provides the clock difference between the two sides. If both sides are synchronized, the difference is 0 (over a longer period of time) and the second measurement does not change the results of the first measurement.
Side A uses a counter ctrAA that increases with each cycle of its own clock.
The TDMoIP mechanism periodically sends data packets to the opposite side according to its own send clock. This means that periodically packets go from side A to side B and from side B to side A.
Side A uses a counter ctrAB, which is incremented each time a packet is received from side B.
Side A calculates: ctrDiffA=ctrAB−ctrAA.

### Combination of the Two Measurements

To arrive at the final results, Side A must combine the results of both measurements. This result is calculated as:

RelativeDifferentialDelay=ddA+2xctrDiffA

This combination gives very accurate results, comparable to a measurement with an external test device.

1. A method for transmitting data between two endpoints A, B, requiring in particular a common TimeOfDay at both endpoints A, B in order to monitor the differential delay, the method transmitting and receiving time stamps from both sides since both use the same time reference, wherein the differential delay measurement is made by combining the results of two measurements into a single number indicating the change in differential delay compared to the differential delay at the beginning of the measurement.

2. The method according to claim 1, wherein with a first measurement the transmission delay change between side A and side B and with a second measurement the clock difference between side A and side B are determined.

3. The method according to claim 2, wherein the first measurement is performed in that
Side A and side B each have a counter which is incremented with each cycle of its own internal clock,
Side A sends a message to side B at local time tA1,
Side B receives the message at local time tB1 and acknowledges the message and includes the value of tB1 in the message,
Side A receives the acknowledgement at local time tA2, and
Side A calculates (i) the round trip time rA1=tA2−tA1 and (ii) the initial offset offsetA1=tB1−tA1−rA1/2.

4. The method according to claim 2, wherein the second measurement is used to correct the first measurement if both sides are no longer synchronized, in which case the local times on both sides are no longer frequency synchronized.

5. The method according to claim 4, wherein for result correction the second measurement compares the clock frequencies of both sides A, B by considering the internal transmission rate and the rate of incoming packets, the difference in transmission and reception rate providing the clock difference between both sides A and B.
